(19) United States
(12) Patent Application Publication
(10) Pub. No.: US 2013/0004383 A1
(43) Pub. Date: Jan. 3, 2013

(54) STAND-ALONE FLUE GAS RECIRCULATION FAN

(75) Inventors: Brent Stang, Calgary (CA); Peter H. Johnson, Calgary (CA)

(73) Assignee: FLUOR TECHNOLOGIES CORPORATION, Aliso Viejo, CA (US)

(21) Appl. No.: 13/538,629

(22) Filed: Jun. 29, 2012

Related U.S. Application Data
(60) Provisional application No. 61/503,347, filed on Jun. 30, 2011.

(51) Int. Cl. B01J 10/00; B23P 11/00; B01D 29/00

(52) U.S. Cl. 422/187; 422/234; 137/15.01

(57) ABSTRACT

The formation of pollutants in a hydrocarbon reformer is reduced by use of flue gas recirculation. In typical systems and methods, a hydrocarbon reformer has air intake from an air intake fan where the hydrocarbon reformer produces flue gas exhaust. A portion of the flue gas exhaust is fed into an induced draft fan, wherein a flue gas recirculation (“FGR”) fan draws a portion of the flue gas exhaust located downstream of the induced draft fan. The portion of the flue gas is drawn towards an air intake conduit downstream of the air intake fan, which reduces a flame temperature within the hydrocarbon reformer and reduces the formation of NOₓ.

This application claims the benefit of priority to U.S. provisional application having Ser. No. 61/503347 filed on Jun. 30, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is flue gas recirculation by use of a fan.

### BACKGROUND

The background description includes information that may be useful in understanding the present invention. It is not an admission that any of the information provided herein is prior art or relevant to the presently claimed invention, or that any publication specifically or implicitly referenced is prior art.

It is generally known to reform naturally found hydrocarbons, such as fossil fuels, into useful products, such as hydrogen gas or oil. Typically, the hydrocarbon is fed into a reformer, and is heated to reform the hydrocarbon into a useful product and a waste product. Where the waste product is a gas, the waste product may be piped into the atmosphere so long as the concentration of greenhouse gases or pollutants does not exceed a threshold level. However, because of the reformation process, waste product can contain a high concentration of greenhouse gases, such as carbon dioxide, which needs to be filtered and captured in order to minimize the amount of greenhouse gases that are released through the reformation process.

However, capturing from a waste product could increase the concentration of pollutants because the diluent effect of the carbon dioxide is reduced and/or eliminated, also increasing the number of greenhouse gas emissions. U.S. Pat. Publ. No. 20030148236 to Joshi teaches a method of introducing staging burners before the waste product enters a flue stack in order to burn any pollutant NOₓ gas. However, such a configuration would increase the amount of carbon dioxide created, which would need to be recaptured in some manner.

In addition, U.S. Pat. Publ. No. 2010/0252776 to Farmayan teaches a method of injecting oxygen into a combustion reformation chamber in order to minimize the amount of carbon dioxide that is produced by the reformation process. Farmayan also recaptures the recycle stream and adds oxygen in order to improve the amount of oxygen being sent to the reformer. Farmayan, however, provides a rather expensive process since it requires a continuous supply of oxygen to be continuously piped into the reformation chamber and requires the entire reformer pipeline to be reconstructed in order to handle the new oxygen intake valve.

U.S. Pat. Publ. No. 20110146991 to Palamara teaches a hydrogen reformer that captures carbon dioxide from the waste product through a carbon dioxide absorbing wash stream. However, when carbon dioxide capture is implemented on a reformer, the concentration of NOₓ in the waste product will increase because the diluent effect of carbon dioxide is greatly reduced.

U.S. Pat. No. 6,599,119 to Wood discloses a combustion apparatus that contains a post combustion hot gas fan and a recirculation duct downstream from the hot gas fan. In operation, a portion of the flue gas exhaust from the combustion is recycled into the air feed line to control NOₓ emissions. However, the Wood system is undesirable for use with reformers because the introducing of the flue gas upstream of the forced draft fan would likely require modifying existing equipment, which could add significant expense.

Thus, there is still a need for improved systems and methods for reforming hydrocarbons while minimizing greenhouse gases and other pollutants released into the atmosphere.

### SUMMARY OF THE INVENTION

The inventive subject matter provides apparatus, systems and methods in which one can use a flue gas recirculation fan to reduce the formation of pollutants produced in a hydrocarbon reformer. In a typical operation, a hydrocarbon reformer having an air intake from an air intake fan produces a flue gas exhaust. Preferably, it is contemplated that the air intake fan is a forced draft fan. A portion of the flue gas exhaust is fed into an induced draft fan, and a flue gas recirculation (“FGR”) fan can be used to draw a first portion of the flue gas exhaust from downstream of the induced draft fan. The first portion of the flue gas is directed by the FGR fan towards the air intake downstream of a discharge of the air intake fan in an amount effective to reduce a flame temperature within the hydrocarbon reformer.

In another aspect, methods of retrofitting a hydrocarbon reforming systems are contemplated. Preferred methods include a hydrocarbon reformer, an air intake fan, and an induced draft fan, which collectively are used with a FGR fan to reduce the formation of pollutants in the hydrocarbon reformer. The input of the FGR fan can be coupled to a flue gas exhaust conduit that is downstream of an induced draft fan. In most typical operations, the induced draft fan is fluidly coupled to the hydrocarbon reformer. The output of the FGR fan can be coupled to an air intake conduit downstream of an air intake fan discharge. The air intake conduit can be fluidly coupled to the hydrocarbon reformer. A portion of a flue gas produced by the hydrocarbon reformer can be diverted to the air intake conduit, such that the mixture of the flue gas with the air intake is sufficient to reduce a flame temperature within the hydrocarbon reformer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an example of a system for reducing the formation of pollutants in a hydrocarbon reformer that includes a carbon capture module and a filtration unit.

FIG. 2 is a schematic of another example of a system for reducing the formation of pollutants in a hydrocarbon reformer.

FIG. 3 is a schematic of another embodiment of a system for reducing the formation of pollutants in a hydrocarbon reformer that include louvers.

FIG. 4 is a schematic of another embodiment of a system for reducing the formation of pollutants in a hydrocarbon reformer that includes a variable frequency drive.

FIG. 5 is a schematic of an example of a method of retrofitting a hydrocarbon reforming system that includes a hydrocarbon reformer to reduce the formation of pollutants in the hydrocarbon reformer.

### DETAILED DESCRIPTION

One should appreciate that the disclosed techniques provide many advantageous technical effects including reducing the need to modify existing fans while reducing a flame temperature within the hydrocarbon reformer and thereby reducing NOₓ levels.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

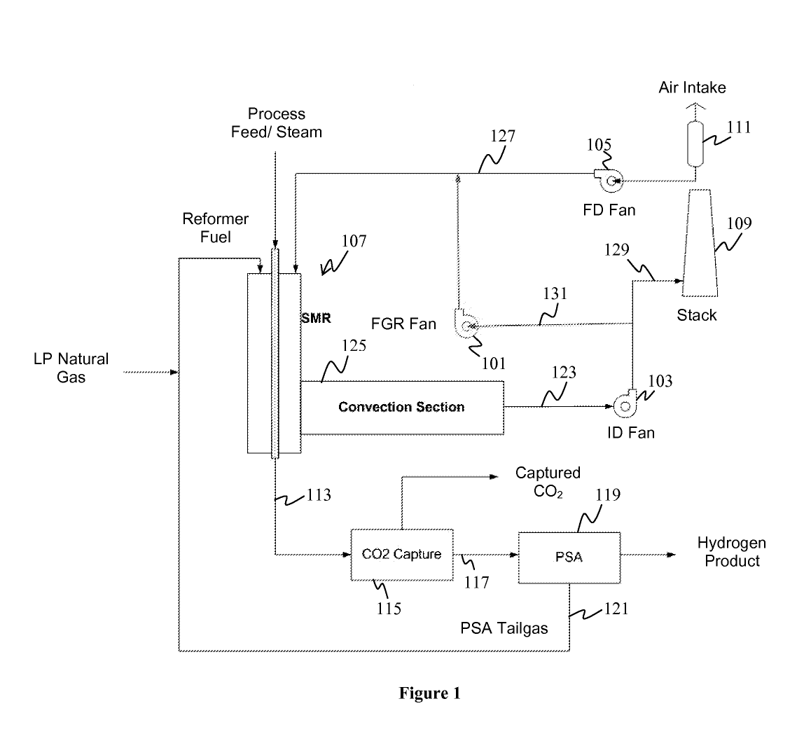

In FIG. 1, an exemplary embodiment of a system for reducing the formation of pollutants in a hydrocarbon reformer is illustrated. A flue gas recirculation (“FGR”) fan 101 is installed downstream of an induced draft fan 103 and downstream of an air intake fan 105. In preferred systems, the induced draft fan 103 is disposed and configured to draw gas from the combustion chamber of the hydrocarbon reformer 107 towards an exhaust stack 109. The gas drawn by the induced draft fan 103 is typically at high temperature and low pressure. In preferred systems, the air intake fan 105 is a forced draft fan that draws external air from an air intake 111 towards the combustion chamber of the hydrocarbon reformer 107. Typically, the air drawn by the air intake fan 105 is at low pressure and low temperature, although the specific parameters will depend on the application. Furthermore, the air drawn by the air intake 111 could be atmospheric, room temperature air, piped in from outside, but is preferably heated and/or pressurized, and could be treated with oxygen or other gases to improve its combustive effects.

As shown in FIG. 1, the hydrocarbon reformer 107 is preferably a steam methane reformer (“SMR”) that heats and pressurizes a feed stream with a catalyst to reform the feed stream into a product stream of the hydrocarbon reformer 113, which can be a syngas, for example (a mixture of hydrogen and carbon dioxide/carbon monoxide). However, it is alternatively contemplated that other hydrocarbon reformers could be utilized without departing from the scope of the invention. The product stream of the hydrocarbon reformer 113 can then be fed into a carbon dioxide (“CO₂”) capturing module 115 that captures carbon dioxide. It is contemplated that any known CO₂ capturing module could be employed, such as scrubbing or chemical looping combustion.

After the CO₂ has been reduced by the CO₂ capture module 115, a product stream of the carbon dioxide capture module 117 can be fed into a filtration unit 119 that filters hydrogen product and produces a tailgas 121. In preferred systems, the filtration unit 119 is a pressure swing adsorber (“PSA”), although any commercially suitable filtration unit could be used. The tailgas 121 can finally be fed into the hydrocarbon reformer 107, typically in the combustion chamber.

Consequently, due to the reduction of CO₂ by the CO₂ capture module 115, the mass flow of tailgas 121 that is fed to the hydrocarbon reformer 107 is also reduced. As a result, the amount of inerts in the tailgas 121 is reduced, which causes an increase in the burner temperature of the hydrocarbon reformer 107 and results in increased NOₓ levels. However, it is contemplated that the reduced mass flow of inerts can be counterbalanced by flue gas recirculation. Accordingly, the amount of flow within the hydrocarbon reformer 107 can be relatively the same as a hydrocarbon reformer that does not have a CO₂ capture module or an FGR fan.

To address the issue of increased burner temperature and NOₓ levels, flue gas exhaust 123 from the hydrocarbon reformer 107 can be recirculated within the system to reduce the effects caused by the loss of carbon dioxide. In typical systems, the flue gas exhaust 123 is sent to a convection chamber 125, which can be configured to use heat from the flue gas in other operations. The convection chamber 125 can be further configured to draw heat from the flue gas exhaust 123 before the flue gas exhaust 123 passes by induced draft fan 103.

As shown in FIG. 1, a FGR fan 101 is preferably installed downstream of the induced draft fan 103, such that the FGR fan 101 draws a first portion 131 of the flue gas exhaust 123. A second portion 129 of the flue gas exhaust 123 can be sent to a stack 109. After passing by the FGR fan 101, the first portion 131 of the flue gas exhaust 123 can be fed into an air intake conduit 127, preferably downstream from a discharge of the air intake fan 105. In this manner, the mixture of the first portion 131 of the flue gas 123 with the air advantageously can reduce the flame temperature within the hydrocarbon reformer 107, which thereby reduces NOx formation.

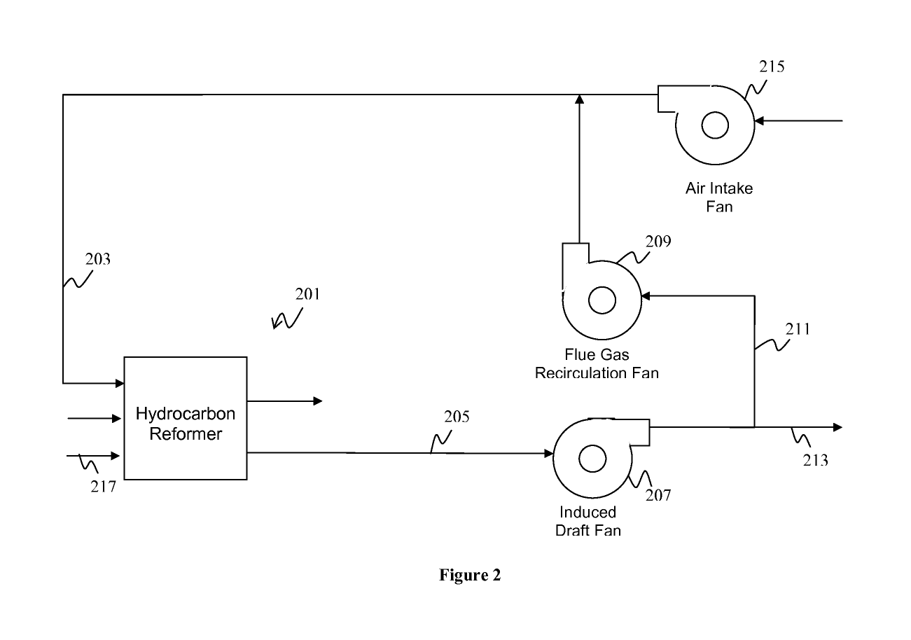

In FIG. 2, another embodiment is illustrated of a system of reducing pollutants in a hydrocarbon reformer. Generally, preferred systems comprise a hydrocarbon reformer 201, an induced draft fan 207, and an air intake fan 215. In some contemplated embodiments, a FGR fan 209 can be added to the system's existing hydrocarbon reformer 201, induced draft fan 207, and air intake fan 215 to thereby reduce pollutants emitted from the reformer 201 without a need for modifying the system's existing fans such as would be required by prior art systems known to Applicants. This can significantly reduce the otherwise cost of modifying the system to comply with more stringent environment regulations. The FGR fan 209 is preferably disposed and configured to draw a first portion 211 of a flue gas exhaust into the air intake conduit 203.

The system can further include additional components. For example, the system can comprise of additional heat exchangers, valves, or other process units. In typical systems, the FGR fan 209 can be added without retooling the air intake fan 215 and/or the induced draft fan 207. In other words, the recirculation fan 209 can be added into a system comprising an induced draft fan 207 and an air intake fan 215, while maintaining the operational characteristics of the induced and forced draft fans. As a result, retooling is favorable because it can reduce costs and downtime to reconfigure existing systems. With respect to the remaining numerals in FIG. 2, the same considerations for like components with like numerals of FIG. 1 apply.

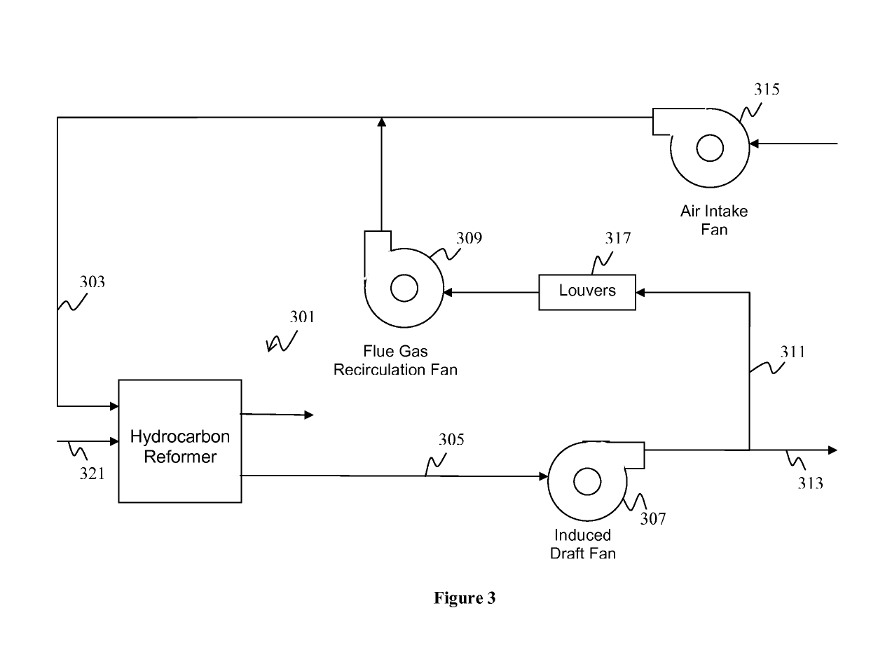

In FIG. 3, an illustration is shown of an exemplary embodiment of a system for reducing the formation of pollutants further comprising louvers 317 that could be installed in the junction between the induced draft fan 307 and the flue gas recirculation fan 309. It is contemplated that the louvers 317 can be also be configured to adjust a ratio of a first portion of the flue gas exhaust 311 and a second portion of the flue gas exhaust 313. Moreover, it is contemplated that the louvers 317 can control the flow of flue gas exhaust 311 as a ratio of the concentration of NO_{R}, such that the louvers 317 could increase the amount of flue gas exhaust 311 sent towards the FGR fan 309 if a concentration of NOx in the combustion chamber increases above a threshold level. Another contemplated aspect involves the louvers 317 functioning as a ratio of the first portion of the flue gas exhaust 311 and the second portion of the flue gas exhaust 313 with respect to an air pressure of a tailgas 321. In such a contemplated aspect, the louvers 317 could increase the amount of flue gas exhaust 311 sent towards the FGR fan 209 if the air pressure of the hydrocarbon reformer 301 drops below a threshold level. Finally, the louvers 317 could adjust the amount of flue gas exhaust 311 sent towards the FGR fan 309 to maintain a given pressure within the hydrocarbon reformer 301. With respect to the remaining numerals in FIG. 3, the same considerations for like components with like numerals of FIG. 1 apply.

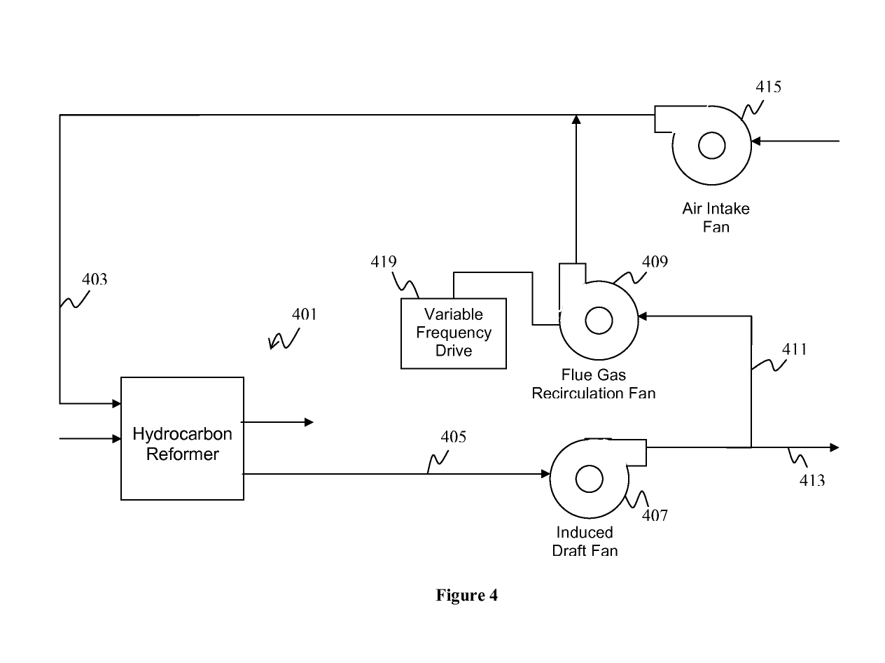

In FIG. 4, an exemplary embodiment is illustrated wherein a variable frequency drive 419 is controlling a characteristic of the flue gas recirculation fan 409. It is contemplated that the variable frequency drive 419 can control the various aspects covered by the louvers in FIG. 3. As a result, it is shown that the disclosed concepts can be applied to a plurality of existing systems whereby a reduction in the formation of pollutants is needed. With respect to the remaining numerals in FIG. 4, the same considerations for like components with like numerals of FIG. 1 apply.

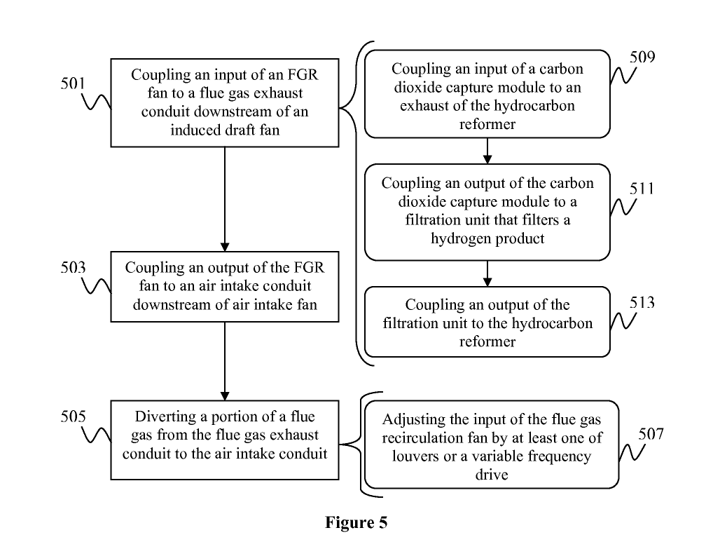

In another aspect, methods are contemplated of retrofitting an existing hydrocarbon reforming system that includes a hydrocarbon reformer, an air intake fan, and an induced draft fan to reduce the formation of pollutants in the hydrocarbon reformer. In FIG. 5, an exemplary embodiment of a method of retrofitting a hydrocarbon reforming system is illustrated. In step 501, an input of a flue gas recirculation fan is coupled to a flue gas exhaust conduit downstream of an induced draft fan. In typical methods, the flue gas exhaust conduit can be fluidly coupled to the hydrocarbon reformer. Furthermore, an output of the flue gas recirculation fan is coupled to an air intake conduit downstream of an air intake fan discharge 503. It is contemplated that the air intake conduit can be fluidly coupled to a hydrocarbon reformer. In step 505, a portion of a flue gas is diverted from the flue gas exhaust conduit to the air intake conduit in an amount effective to reduce a flame temperature within the hydrocarbon reformer. In addition, it is contemplated that the flue gas recirculation fan can be adjusted by at least one of louvers or a variable frequency drive 507.

Furthermore, it is contemplated that the methods herein can comprise of a carbon capture module and a filtration unit. In such embodiment, an input of a carbon dioxide capture module can be coupled to an exhaust of the hydrocarbon reformer 509. Thereafter, an output of the carbon dioxide capture module can be coupled to a filtration unit that filters a hydrogen product 511. Finally, an output of the filtration unit can be coupled to the hydrocarbon reformer 513.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for reducing the formation of pollutants produced in a hydrocarbon reformer, comprising:
a hydrocarbon reformer having an air intake from an air intake fan, wherein the hydrocarbon reformer produces flue gas exhaust at least a portion of which feeds into an induced draft fan; and
a flue gas recirculation (“FGR”) fan that draws a first portion of the flue gas exhaust downstream of the induced draft fan towards an air intake conduit downstream from a discharge of the air intake fan in an amount effective to reduce a flame temperature within the hydrocarbon reformer.

2. The system of claim 1, wherein the air intake fan is a forced draft fan.

3. The system of claim 1, wherein the first portion of the flue gas exhaust is an amount effective to reduce the formation of NOₓ in the hydrocarbon reformer.

4. The system of claim 1, wherein the induced draft fan directs a second portion of the flue gas exhaust towards an exhaust stack.

5. The system of claim 1, further comprising at least one of louvers and a variable frequency drive configured to adjust a ratio of the first portion of the flue gas exhaust and the second portion of the flue gas exhaust.

6. The system of claim 5, wherein the at least one of louvers and the variable frequency drive adjusts the ratio as a function of a concentration of NOₓ.

7. The system of claim 1, further comprising a carbon dioxide capture module that captures carbon dioxide from a product stream of the hydrocarbon reformer.

8. The system of claim 7, further comprising a filtration unit that filters hydrogen product from a product stream of the hydrocarbon reformer.

9. The system of claim 8, wherein the filtration unit is a pressure swing adsorber.

10. The system of claim 8, wherein a tailgas from the filtration unit is fed into a combustion chamber of the hydrocarbon reformer.

11. The system of claim 10, further comprising at least one of louvers and a variable frequency drive configured to adjust a ratio of the first portion of the flue gas exhaust and the second portion of the flue gas exhaust as a function of an air pressure of the tailgas.

12. The system of claim 1, further comprising a convection chamber that draws heat from the flue gas exhaust before the flue gas exhaust enters the induced draft fan.

13. A method of retrofitting a hydrocarbon reforming system that includes a hydrocarbon reformer, an existing air intake fan, and an existing induced draft fan to reduce the formation of pollutants in the hydrocarbon reformer, comprising:
coupling an input of a flue gas recirculation fan to a flue gas exhaust conduit downstream of an induced draft fan, wherein the flue gas exhaust conduit is fluidly coupled to the hydrocarbon reformer;
coupling an output of the flue gas recirculation fan to an air intake conduit downstream of an air intake fan discharge, wherein the air intake conduit is fluidly coupled to the hydrocarbon reformer; and
diverting a portion of a flue gas from the flue gas exhaust conduit to the air intake conduit in an amount effective to reduce a flame temperature within the hydrocarbon reformer.

14. The method of claim 13, wherein the air intake fan is a forced draft fan.

15. The method of claim 14, wherein the steps of coupling input and output of the flue gas recirculation fan further comprises retaining the existing induced draft fan and air intake fan.

16. The method of claim 13, further comprising adjusting the input of the flue gas recirculation fan by at least one of louvers or a variable frequency drive.

17. The method of claim 13, further comprising coupling an input of a carbon dioxide capture module to an exhaust of the hydrocarbon reformer.

18. The method of claim 17, further comprising coupling an output of the carbon dioxide capture module to a filtration unit that filters a hydrogen product.

19. The method of claim 18, further comprising coupling an output of the filtration unit to the hydrocarbon reformer.

20. The method of claim 13, further comprising reducing the formation of NOₓ in the hydrocarbon reformer.
